(19) United States
(12) Patent Application Publication
(10) Pub. No.: US 2026/0225725 A1
(43) Pub. Date: Aug. 6, 2026

(54) SPEED CONTROL METHOD AND CONTROL DEVICE

(71) Applicant: SAFRAN, Paris (FR)

(72) Inventors: Damien Jacques Arthur BONHOMME, Moissy-Cramayel (FR); Ana TRUC-HERMEL, Moissy-Cramayel (FR); Guillaume François Daniel BIDAN, Moissy-Cramayel (FR)

(73) Assignee: SAFRAN, Paris (FR)

(21) Appl. No.: 19/149,335

(22) PCT Filed: Jan. 17, 2024
(86) PCT No.: PCT/FR2024/050063

§ 371 Date: Jul. 18, 2025

(30) Foreign Application Priority Data
Jan. 18, 2023 (FR) FR2300467

(51) Int. Cl. B64D 31/18; B64D 27/357; B64D 31/06

(52) U.S. Cl. CPC B64D 31/18; B64D 27/357; B64D 31/06

(57) ABSTRACT

A method for controlling the speed of an engine assembly of an aircraft. The engine assembly includes at least a combustion engine and an electric machine mechanically coupled to the combustion engine and electrically connected to an onboard energy storage device of the aircraft. The method includes steps of comparing an electrical reserve required for engine assistance with an available electrical reserve, and controlling the speed of the engine assembly as a function of the difference between the electrical power reserve required for engine assistance and the available electrical power. A control device suitable for implementing this method, as well as the engine assembly and aircraft incorporating the control device.

### TECHNICAL FIELD

The present invention relates to the technical field of the control of aircraft engine assemblies, and more particularly to aircraft engine assemblies comprising at least one electric machine and a combustion engine, in particular a gas turbine engine.

### PRIOR ART

In order to increase the overall energy efficiency of transport means, and to reduce their fuel consumption and greenhouse gas emissions, increasing electrification of engine assemblies is being considered. In the aviation field, there is in particular a trend towards extracting increasing power through electric machines incorporated into engine assemblies, in particular to replace pressurised air extraction for auxiliary devices. In addition, there are many hybrid engine assemblies in which these electric machines are used not only to extract power, but also to introduce it into the engine assembly in order to provide assistance beyond simple start-up. Although these hybrid engine assemblies have most often been proposed for automotive vehicles and incorporate piston engines, hybridisation of aircraft engine assemblies and more particularly engine assemblies incorporating one or more gas turbine engines has also been considered.

Hybridisation of aircraft engine assemblies requires the incorporation in the aircraft of on-board energy storage devices to supply the power to be introduced into the engine assembly via the electric machine. These on-board energy storage devices can take the form, in particular, of rechargeable electric batteries, although other energy storage devices, such as supercapacitors or flywheels for example, are also possible. In order to recharge these on-board energy storage devices, hybridisation will normally further increase the amount of electrical power extracted from the engine assembly during operating phases that do not require electrical assistance, in particular at lower outputs.

During idle phases on the ground and in flight, it is normally desirable to minimise thrust and therefore engine assembly output. However, this output is normally constrained by the operability stops of the engine assembly and by the requirement for an ability to respond to transient fluctuations in the power extraction, both in the context of a sudden decrease (load release) and in the context of a sudden increase, due for example to a short-circuit. The ability of combustion engines, and in particular gas turbine engines, to absorb these sudden fluctuations increases with engine output. However, their fuel consumption then also increases. In addition, an increase in engine output may also imply an increase in thrust exerted on the aircraft, which could be undesirable in certain circumstances, for example during descent phases.

In European patent application EP 3 845 750 A1, an engine assembly was proposed incorporating a gas turbine engine with two rotating shafts, as well as an electric machine coupled to each of the rotating shafts, and a method of distributing power extraction between these rotating shafts as a function of the engine output.

In French patent application FR 3 097 012 A1, it was proposed to use hybridisation of the engine assembly to improve its response to load fluctuations, in particular at idle outputs.

In international patent application WO 2021/018524 A1, it is proposed to use an on-board energy storage device to help reduce transient fluctuations in power extraction from an aircraft engine assembly.

However, the ability of an on-board energy storage device to reduce transient fluctuations in power extraction from an aircraft engine assembly will normally depend on its state of charge.

### Disclosure of the Invention

The objective of the present invention is to provide an output regulation method and a control device for an aircraft engine assembly, comprising at least one combustion engine and one electric machine mechanically coupled to the combustion engine and electrically connected to an on-board energy storage device of the aircraft, to enable electrical assistance to be provided to the engine assembly via the electric machine while taking into account the availability of the on-board energy storage device.

For this purpose, according to a first aspect of this invention, this method may comprise at least the steps of comparing an electrical reserve required for engine assistance with an available electrical reserve and controlling the output of the engine assembly as a function of a difference between the electrical reserve required for engine assistance and the available electrical reserve. The method may also comprise a step of estimating the electrical reserve required for engine assistance on the basis of at least one current output of the engine assembly. Furthermore, at least one other aircraft operating parameter, such as the speed and/or altitude of the aircraft, can also be taken into account in the step of estimating the electrical reserve required for engine assistance.

Thus, the output of the engine assembly can be controlled so that the available electrical reserve can cover the electrical reserve that may be required for engine assistance at this output. In particular, the output of the engine assembly can remain an idle output lower than a maximum nominal output of the engine assembly, in particular less than or equal to 70% of said maximum nominal output. The output of the engine assembly can be taken to mean the speed of rotation of a shaft of the engine assembly. However, other definitions of engine assembly output are also possible: for example, engine assembly output can alternatively be defined in terms of thrust.

According to a second aspect, an increase in the output of the engine assembly and/or recharging of the on-board energy storage device can be controlled, at the time of the output change command, when the electrical reserve required for engine assistance is greater than the available electrical reserve. In particular, the increase in the output of the engine assembly can be an increase towards a higher setpoint enabling a value for the electrical reserve required for engine assistance less than or equal to the available electrical reserve to be achieved. The recharging of the on-board energy storage device enables the available electrical reserve to be increased, and can optionally be carried out without increasing the output of the engine assembly, in particular when the mechanical energy extracted by the electric machine from the combustion engine can be increased without increasing the engine output.

In a third aspect, the electrical reserve required for engine assistance may comprise a required reserve of electrical power, and the available electrical reserve may comprise an available reserve of electrical power. In this case, the method may comprise steps of estimating an electrical power that can be supplied by the on-board energy storage device on the basis of a current state of charge of the on-board energy storage device, and calculating the available electrical power reserve by subtracting an electrical power consumed by electrical loads of the aircraft from the electrical power that can be supplied by the on-board energy storage device. However, alternatively or in addition to these powers, the electrical reserve required for engine assistance may comprise a required reserve of electrical energy, and the available electrical reserve comprises an available reserve of electrical energy. Thus, it is possible to cover the need for instantaneous electrical assistance and the need for transient assistance over a period of time.

In a fourth aspect, a reduction in the output of the engine assembly can be controlled, at the time of the output change command, when the available electrical reserve is greater than the required electrical reserve. The reduction in the output of the engine assembly may, in particular, be a reduction towards a lower setpoint, where the electrical reserve required for engine assistance does not yet exceed the available electrical reserve, but which may remain at least equal to a lower operability stop.

A fifth aspect relates to a control device suitable for implementing the method according to any of the preceding aspects.

A sixth aspect relates to a computer program comprising instructions that cause the control device of the fifth aspect to implement the method of any one of the preceding aspects.

A seventh aspect relates to an aircraft engine assembly comprising a control device according to the fourth aspect, the combustion engine and the electric machine. The combustion engine may be a gas turbine engine.

An eighth aspect concerns an aircraft comprising an engine assembly according to the seventh aspect, as well as an on-board energy storage device electrically connected to said electric machine of the engine assembly and could, in particular, be a rechargeable battery.

### BRIEF DESCRIPTION OF THE DRAWINGS

FIG. 1 is a schematic representation of the electrical and control networks of an aircraft.

FIG. 2 is a flow chart of a method for controlling the output of an engine assembly of the aircraft of FIG. 1.

FIG. 3 is a flow chart of a subroutine for increasing the output in the method of FIG. 2.

FIG. 4 is a flow chart of a subroutine for decreasing the output in the method of FIG. 2.

FIG. 5 is a graph illustrating an example of the change in output, state of charge and electrical power over time during execution of the method of FIG. 2.

### DESCRIPTION OF THE EMBODIMENTS

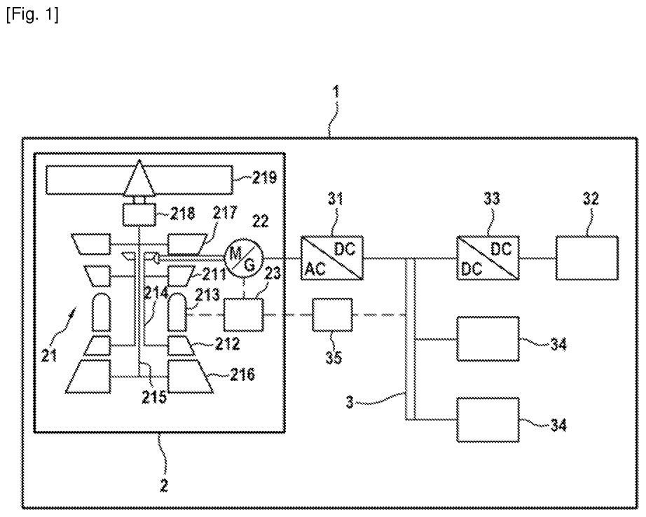

As illustrated in FIG. 1, an aircraft 1 may comprise one or more engine assemblies 2, each of which may include at least one combustion engine 21, in particular in the form of a gas turbine engine, comprising at least one compressor 211, a turbine 212, a combustion chamber 213 disposed in a stream of air between the compressor 211 and the turbine 212, and a rotary shaft 214 mechanically connecting the compressor 211 and the turbine 212. In particular, as illustrated, such a gas turbine engine may be a turbofan engine, comprising at least one other rotary shaft 215 concentric with the rotary shaft 214 and mechanically connecting another turbine 216 downstream of the turbine 212 to another compressor 217 upstream of the compressor 211, as well as, possibly through a reducer 218, to a fan 219, which may be ducted or unducted. However, the present invention is not limited to turbofan engines or even to gas turbine engines, being equally applicable to other types of gas turbine engines, such as turboprops or turboshaft engines, or even to other types of combustion engines, such as piston engines.

As also illustrated in FIG. 1, each engine assembly 2 may also comprise an electric machine 22 coupled to a rotary shaft of the combustion engine, such as the rotary shaft 214 for example. This electric machine 22 may, in particular, be a generator able to extract electrical power from the engine assembly 2, or alternatively to provide electrical assistance to the engine assembly 2. This electric machine 22 may be electrically connected to an electrical network 3 of the aircraft 1, for example via a converter 31, which may in particular be an AC/DC converter as illustrated. The aircraft 1 may also comprise one or more on-board energy storage devices 32, each also connected to the electrical network 3, for example via a converter 33, which may in particular be a DC/DC converter as illustrated. These on-board energy storage devices 32 may in particular take the form of rechargeable batteries configured to store energy electrochemically. However, other types of on-board energy storage devices are also possible, as an alternative to or in combination with rechargeable batteries, such as flywheels or supercapacitors. In addition, the aircraft 1 may also comprise one or more electrical loads 34 also connected to the electrical network 3.

As also illustrated in FIG. 1, each engine assembly 2 may also include a control device 23 connected to the combustion engine 21 and to the electric machine 22 in order to control the output of the engine assembly 2. This control device 23 can, in particular, take the form of an electronic control unit. The control device 23 can be connected to the combustion engine 21 to control, for example, its fuel supply and/or the position of variable geometry elements of the combustion engine 21, such as blades, vanes, discharge valves and/or the nozzle. In addition, the control device 23 can be connected to the electric machine 22 to control the electrical power extracted from or injected into the engine assembly 2 through the electric machine 22. In addition, the aircraft may comprise at least one other control device 35, which can be connected to the control device 23, the converters 31, 33, the on-board energy storage devices 32, and/or the electrical loads 34, in order to control energy transfers through the electrical network 3. This other control device 35 may also take the form of an electronic control unit. Furthermore, although the control devices 23, 35 are presented here as two separate devices, it would also be possible to combine them into a single device, and in particular into a single electronic control unit.

The control device 23 can be adapted to implement a process for controlling the output of the engine assembly 2, in particular for slower outputs, both in flight and on the ground.

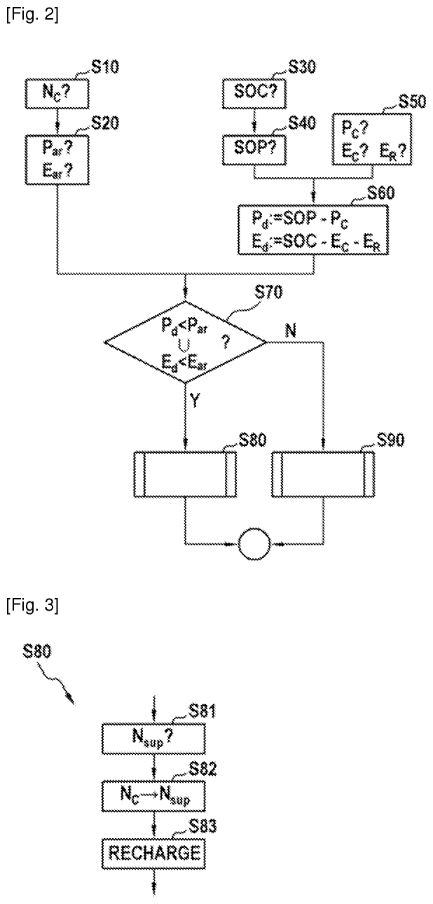

Thus, as illustrated in FIG. 2, a cycle of this control method, which may be repeated regularly, may comprise a step S10 of obtaining operating parameters for the engine assembly 2, or even of the aircraft 1. These operating parameters may include, in particular, the current output N_{c} of the engine assembly 2, but also other parameters such as temperature, pressure, aircraft speed, altitude, etc. This step S10 can then be followed by a step S20 of estimating an electrical reserve required for any electrical assistance of the engine assembly 2, via the electric machine, at these operating parameters, and in particular at the current output N_{c} of the engine assembly 2. This electrical assistance can, for example, respond to a sudden demand for additional thrust, to the connection of an additional load to the engine assembly or to a fault such as a short-circuit. In the estimation step S20, the electrical reserve required to be able to ensure this electrical assistance, in particular at the current output N_{c} of the engine assembly 2, may, for example, be estimated from a table of correspondences stored in a memory accessible by the control device 23 and containing predefined correspondences between different values of the required electrical reserve and at least the current output N_{c} of the engine assembly 2. This required electrical reserve may, in particular, comprise an electrical power reserve Pₐᵣ required for the electrical assistance, but also, alternatively or in addition thereto, a reserve of electrical energy Eₐᵣ required to provide an electrical assistance power, according to a predetermined profile, throughout the duration of a transient electrical assistance.

As illustrated in FIG. 2, the control method may also comprise a step S30 of obtaining a current state of charge SOC of the energy storage device 32, followed by a step S40 of estimating an electrical power SOP that can be supplied by the on-board energy storage device 32 at this state of charge SOC. This estimate can also be made from a table of correspondences stored in a memory accessible by the control device 23, optionally via the control device 35. The control method may also include a step S50 of obtaining an electrical consumption of the electrical loads 34, which may include an electrical power P_{c} occasionally consumed by the electrical consumers 34, but also, alternatively or in addition thereto, an electrical energy E_{c} consumed by the electrical loads 34 throughout the duration of the transient electrical assistance, or even an additional reserve ER, and the steps S40 and S50 may be followed by a step S60 of calculating an available electrical reserve. This available electrical reserve may comprise an available electrical power reserve P_{d}, which may for example be calculated by subtracting the electrical power P_{c} consumed by the electrical loads 34 from the electrical power SOP that can be supplied by the on-board energy storage device 32 in the current state of charge SOC. Alternatively or in addition to the available electrical power reserve P_{d}, the available electrical reserve may also comprise an available electrical energy reserve E_{d}, which may, for example, be calculated by subtracting the electrical energy E_{c} consumed by the electrical loads 34 throughout the duration of the transient electrical assistance, or even also the additional reserve E_{R}, from the current state of charge SOC. Although several of steps S10 to S60 are illustrated as being carried out in parallel, it is also possible to carry out at least some of them sequentially.

The step S20 of estimating an electrical reserve required for electrical assistance and the step S60 of calculating an electrical reserve actually available for this electrical assistance may be followed by a step S70 of comparing the required electrical reserve with the available electrical reserve P_{d}. If the available electrical reserve is less than the required electrical reserve, in other words, in the illustrated case, if the available electrical power reserve P_{d} is less than the required electrical power reserve Pₐr, and/or the available electrical energy reserve E_{d} is less than the required electrical energy reserve Eₐᵣ, a positive rebalancing subroutine S80 can be performed. On the other hand, if the available electrical reserve is less than or equal to the required electrical reserve, in other words, in the illustrated case, if the available electrical power reserve P_{d} and the available electrical energy reserve E_{d} are respectively greater than or equal to the required electrical power reserve Pₐᵣ and the required electrical energy reserve Eₐᵣ, a negative rebalancing subroutine S90 can be performed.

As illustrated in FIG. 3, the positive rebalancing subroutine S80 may first comprise a step S81 of estimating an upper output setpoint Nₛᵤₚ so that the reserve electrical power Pₐᵣ required for engine assistance becomes less than or equal to the available electrical power P_{d}. For this purpose, the same table of correspondences as in estimation step S20 can be used, albeit in reverse. Next, the output of the engine assembly 2 can be controlled in an output increase step S82 so as to reach the upper setpoint Nₛᵤₚ. Alternatively or in addition to step S81 of estimating the upper output set point Nₛᵤₚ and/or step S82 of increasing output, the positive rebalancing subroutine S80 may also comprise a step S83 of recharging the on-board energy storage device 32 with surplus electrical power generated by the electric machine 22, so as to increase the state of charge SOC of the on-board energy storage device 32 and, by this means, the electrical power SOP that can be supplied by the on-board energy storage device 32 and the electrical power P_{d} available for the engine assistance.

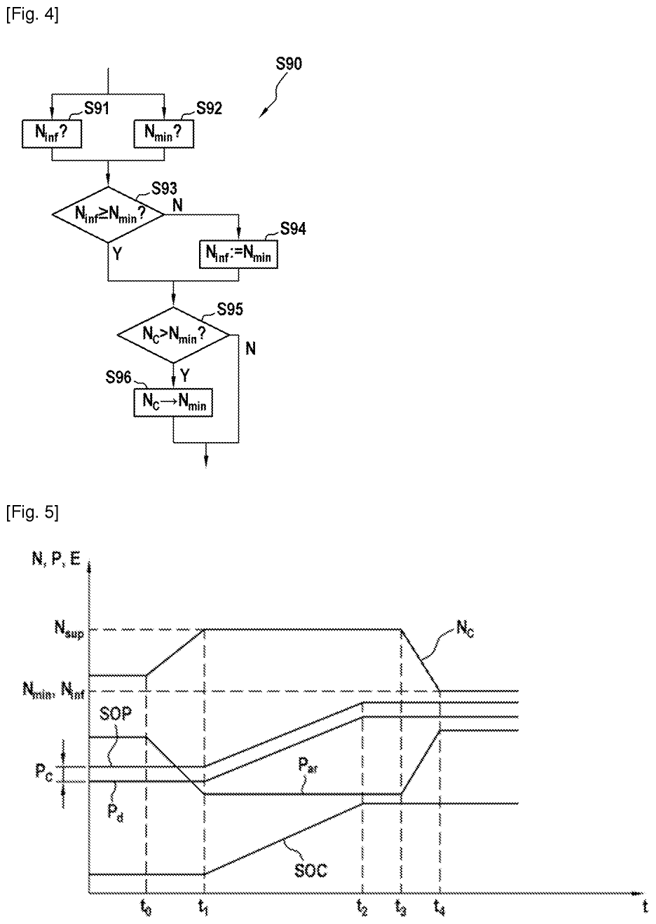

As illustrated in FIG. 4, the negative rebalancing subroutine S90 may first comprise a sub-step S91 of estimating a lower output setpoint N_{inf} such that the electrical reserve required for engine assistance remains less than or equal to the available electrical reserve. For this purpose, the same table of correspondences as in estimation step S20 can also be used in reverse, as in step S81. In parallel, a lower operability stop Nₘᵢₙ can be estimated in a step S92, from the operating parameters of the engine assembly 2 and possibly of the aircraft 1. Then, in a comparison step S93, the lower output setpoint N_{inf} estimated in step S91 can be compared with the lower operability stop Nₘᵢₙ. If the lower output setpoint N_{inf} estimated in step S91 is lower than the lower operability stop Nₘᵢₙ, its value can be replaced, in a step S94, by that of the lower operability stop Nₘᵢₙ. Then, in step S95, the lower output setpoint N_{inf} can be compared with the current output N_{c} of the engine assembly 2. If the lower output setpoint N_{inf} is lower than the current output N_{c} the output of the engine assembly 2 can be controlled, in an output reduction step S96, so as to decrease to the lower setpoint N_{inf} which, by means of steps S93 and S94, will no longer be lower than the lower operability stop Nₘᵢₙ. If the lower output setpoint N_{inf} is not lower than the current output N_{c}, the latter will be able to be maintained.

FIG. 5 illustrates an example of the change over time of the current engine output N_{c}, the reserve of electrical power Pₐᵣ required for engine assistance, the state of charge SOC of the on-board energy storage device 32, the electrical power SOP that can be supplied by the on-board energy storage device 32 and the electrical power P_{d} available for engine assistance. In this example, at initial time t₀, the electrical power P_{d} available for engine assistance is initially less than the electrical power reserve Pₐᵣ required for engine assistance. As a result, an increase in the current engine output N_{c} towards a lower setpoint Nₛᵤₚ is controlled, so as to reduce the required electrical power reserve Pₐᵣ to below the available electrical power P_{d}. When the current engine output N_{c} reaches the upper setpoint Nₛᵤₚ at time t₁, recharging of the on-board energy storage device 32 is controlled until time t₂, so as to thereby increase its state of charge SOC, the electrical power SOP that can be supplied by it, and the electrical power P_{d} available for engine assistance after deduction of the electrical power P_{c} consumed by the electrical loads 34. Thus, at time t₃, during a subsequent cycle of the control process, the available electrical power P_{d} for engine assistance having become significantly greater than the required electrical power reserve Pₐᵣ, a reduction in the current engine output N_{c} towards a lower setpoint N_{inf} Which may be less than or equal to a lower operability stop Nₘᵢₙ, may be controlled, but without the required electrical power reserve Pₐᵣ exceeding the available electrical power P_{d} at the subsequent time t₄.

Although the present invention has been described by referring to specific exemplary embodiments, it is obvious that various modifications and changes can be made to these examples without going beyond the general scope of the invention as defined by the claims. In addition, the individual features of different embodiments mentioned can be combined in additional embodiments. Consequently, the description and the drawings should be considered as illustrating rather than limiting.

1. A method of controlling an engine assembly of an aircraft, wherein the engine assembly comprises at least a combustion engine and an electric machine mechanically coupled to the combustion engine and electrically connected to an on-board energy storage device of the aircraft, the method comprising at least the following steps:
comparing an electrical reserve required for engine assistance with an available electrical reserve, and
controlling the output of the engine assembly as a function of a difference between the electrical reserve required for engine assistance and the available electrical reserve, and
estimating the electrical reserve required for engine assistance on the basis of at least one current output of the engine assembly.

2. The method according to claim 1, wherein at least one other operating parameter of the aircraft is also taken into account in the step of estimating the electrical reserve required for engine assistance.

3. The method according to claim 1, wherein an increase in the output of the engine assembly and/or a recharging of the on-board energy storage device are controlled, when the electrical reserve required for engine assistance is greater than the available electrical reserve.

4. The method according to claim 1, wherein the electrical reserve required for engine assistance comprises a required electrical power reserve and the available electrical reserve comprises an available electrical power reserve.

5. The method according to claim 4, further comprising the following steps:
estimating an electrical power that can be supplied by the on-board energy storage device on the basis of a current state of charge-of the on-board energy storage device,
calculating the available electrical power reserve by subtracting an electrical power consumed by electrical loads of the aircraft from the electrical power that can be supplied by the on-board energy storage device.

6. The method according to claim 1, wherein the electrical reserve required for engine assistance comprises a required electrical energy reserve and the available electrical reserve comprises an available electrical energy reserve.

7. The method according to claim 1, wherein a reduction in the output of the engine assembly is controlled, when the available electrical reserve is greater than the required electrical reserve.

8. The method according to claim 7, wherein the reduction in the output of the engine assembly is a reduction towards a lower setpoint, where the electrical reserve required for engine assistance does not yet exceed the available electrical reserve.

9. The method according to claim 8, wherein said lower set point of the output of the engine assembly remains at least equal to a lower operability stop.

10. A control device suitable for implementing the method according to claim 1.

11. computer program comprising instructions which cause the control device to perform the steps of the method according to claim 1.

12. An engine assembly for an aircraft comprising a control device according to claim 10, the combustion engine and the electric machine.

13. The aircraft engine assembly according to claim 12, wherein the combustion engine is a gas turbine engine.

14. The aircraft comprising an engine assembly according to claim 12, as well as an on-board energy storage device.

15. The aircraft according to claim 14, wherein the on-board energy storage device is a rechargeable battery.
